(19) United States
(12) Patent Application Publication
(10) Pub. No.: US 2004/0109543 A1
(43) Pub. Date: Jun. 10, 2004

(54) Method of accessing an information source

(76) Inventors: Jonathan Engelsma, Hudsonville, MI (US); Sanjay Tibrewal, San Jose, CA (US)

Correspondence Address: MOTOROLA INC, 600 NORTH US HIGHWAY 45, ROOM AS437, LIBERTYVILLE, IL, 60048-5343, US

(21) Appl. No.: 10/314,581

(22) Filed: Dec. 9, 2002

(51) Int. Cl. H04M 11/00

(52) U.S. Cl. 379/88.18

(57) ABSTRACT

A method of retrieving information from an information source (30) is provided. A user (20) is connected with a communication node (16) and a called party at the information source (30). The communication node (16) monitors the call in order to receive and store the instructions that the user (20) inputs in order to obtain certain information. The user (20) may instruct the node (16) as to specific instructions or the node may monitor all the commands that are input. When the user (20) wants information at a later time, the communication node (16) can connect to the third party at the information source (30), retrace the commands the user (20) entered previously and then provide the user with the desired information.

### FIELD OF THE INVENTION

The present invention relates generally to the field of access systems for telecommunication networks.

### BACKGROUND OF THE INVENTION

It is a common occurrence for a user to make a call in order to obtain specific information. Often the user will dial a number and be placed on hold or go directly into an automated system immediately after the call connects. Wait times are usually indeterminate and the user may spend extended periods of time waiting, which may ultimately cause the user to hang up out of frustration. The user may also be forced to give a series of responses (such as punching in a series of numbers) in order to get information. The number of steps involved may be disproportionate to the amount of information the user wants (e.g., pressing 1 then the pound key, then entering an account number and then the pound key to get an account balance). Furthermore, the user may press a series of keys only to end up on hold eventually (e.g., “press 0 to hold for the next available representative.”)

Conventional solutions to the problem of accessing information from an information source have mainly focused on trying to make the users time on the phone interesting in order to encourage the user to stay on the phone. One common technique is the playing of music or informative messages with an occasional interruption message informing the user that he will be attended to in time. Another technique involves playing music or informative messages with occasional interruption messages informing the user of an approximate wait time. The user, however, must still remain on hold and connected without knowing when the called party will answer the call.

In the conventional solutions involving an automated system, the user is kept from being “on hold” because the user is interacting by pressing keys or otherwise answering prompts. However, the user must enter in a series of tedious commands in order to get the information she needs. The user may further have to remain connected to the call, even after pressing many buttons, without knowing when the call will actually be answered by the called party.

Accordingly, it would be desirable to have an efficient reliable system to address the above problems.

### BRIEF DESCRIPTION OF THE DRAWINGS

FIG. 1 is a block diagram of an embodiment of a communication system in accordance with the present invention.

FIG. 2 is a flow chart that illustrates one embodiment of a routine for assisting a user on hold in accordance with the present invention.

FIG. 3 is a flow chart that illustrates another embodiment of a routine for assisting a user on hold in accordance with the present invention.

FIG. 4 is a flow chart that illustrates the first segment of a third embodiment of a routine for assisting a user on hold in accordance with the present invention.

FIG. 5 is a flow chart that illustrates the second segment of a third embodiment of a routine for assisting a user on hold in accordance with the present invention.

FIG. 6 is an exemplary block diagram of one embodiment of a communication system in accordance with the present invention.

### DETAILED DESCRIPTION OF THE PREFERRED EMBODIMENTS

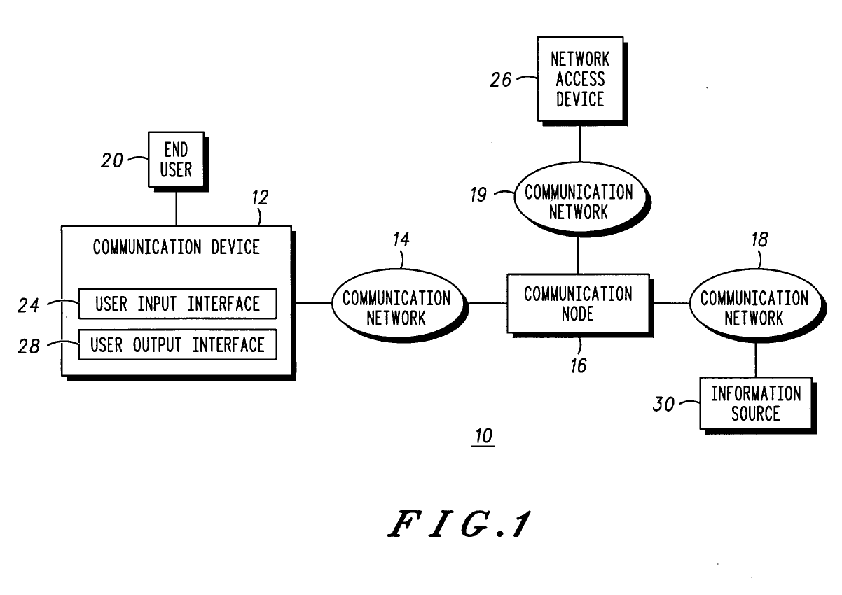

FIG. 1 is a block diagram that illustrates an embodiment of a communication system 10. The communication system 10 generally includes one or more communication devices 12, one or more network access devices, 26, communication networks 14, 18, 19, a communication node 16 and one or more information sources 30. As further described below, the communication system 10 can provide various services and capabilities to cellular end users, wire-line telephone end users, paging end users, satellite end users, mobile or portable telephone end users, trunked end users, computer network end users (e.g., Internet or Intranet end users), wireless data end users, branch office end users and the like. For example, the communication system 10 can provide speech and/or touch-tone recognition, incoming call authorization, call routing, text-to-speech (TTS) and/or speech-to-text (STT) capabilities, content information, messaging services, call screening, interactive voice applications, etc.

The communication devices 12 of the communication system 10 can be utilized by end users 20 to access and/or connect with the communication node 16. The communication devices 12 can include, but are not limited to, wireline telephones, mobile telephones, paging units, radio units, wireless data devices, Internet telephones, portable or wireless telephones, personal information managers (PIMs), personal digital assistants (PDAs), personal computers (PCs), network televisions (TVs), Internet TVs, Internet telephones, portable wireless devices (i.e., two-way pagers), security systems (both mobile and premises-based), workstations or any other suitable communication devices.

Regardless of its specific form, a communication device 12 has user-input interfaces 24 and/or user-output interfaces 28. The user-input interfaces 24 receive input from the end user 20 and the user-output interfaces 28 provide output to the end user 20. The user-input interfaces 24 can include, but are not limited to, an electroacoustic transducer, such as, for example, a microphone to receive voice and other audible input from the end user 20 a keypad or a keyboard to receive key strokes from the end user 20, a touchpad or touchscreen to receive touch input from the end user 20, and a pointing device such as a mouse or a trackball to receive point and click inputs from the end user 20.

The user-output interfaces 28 of the communication devices 12 can include, but are not limited to, an electroacoustic transducer such as, for example, a speaker to provide voice and other audible output to the end user 20 and a visual display device such as a liquid crystal display or a cathode ray tube to provide graphical and/or textual information to the end users 20. It is noted that each of the communication devices 12 may include more than one user-input interface 24 and more than one user-output interface 28. For example, a wireless telephone may have a microphone, a telephone keypad, a speaker, and a visual display device. It is also contemplated that the communication device. May include one or more interfaces which act as both user-output and user-input interfaces

The communication devices 12 communicate with the communication node 16 via the communication networks 14, 18, 19. The communication networks 14, 18, 19 can interface with the communication devices 12 through wireline or wireless networks or systems (i.e., telephone or televisions systems, Integrated Services Digital Network (ISDN) systems, coaxial lines, computer networks, digital end user lines, private networks, wireless local loop systems, etc.).

The communication networks 14, 18, 19 of the communication system 10 can include, but are not limited to, intranets, extranets, the Internet, a Local Area Network (LAN), a telephone network, (e.g., a Public Switched Telephone Network (PSTN), private telephone networks, etc.), a cellular network, satellite networks, a personal communication system, a TV network (e.g., a cable TV system), local, regional, national or global paging networks, an e-mail system, a wireless data network (e.g., satellite data or local wireless data networks), a wireless LAN, a wireless local loop/distribution system (e.g., LMDS, MMDS or Code Division Multiple Access (ODMA) based system), a Voice Over Internet Protocol (VOIP) network, or any other suitable network. The communication networks 14, 18, 19 can also include a wide area network (WAN), such as, for example, the Internet, the World Wide Web (WVVW) or any other similar on-line service. It will be recognized that the communication networks 14, 18, 19 may have portions in common, may comprise two separate networks, or may be the same network.

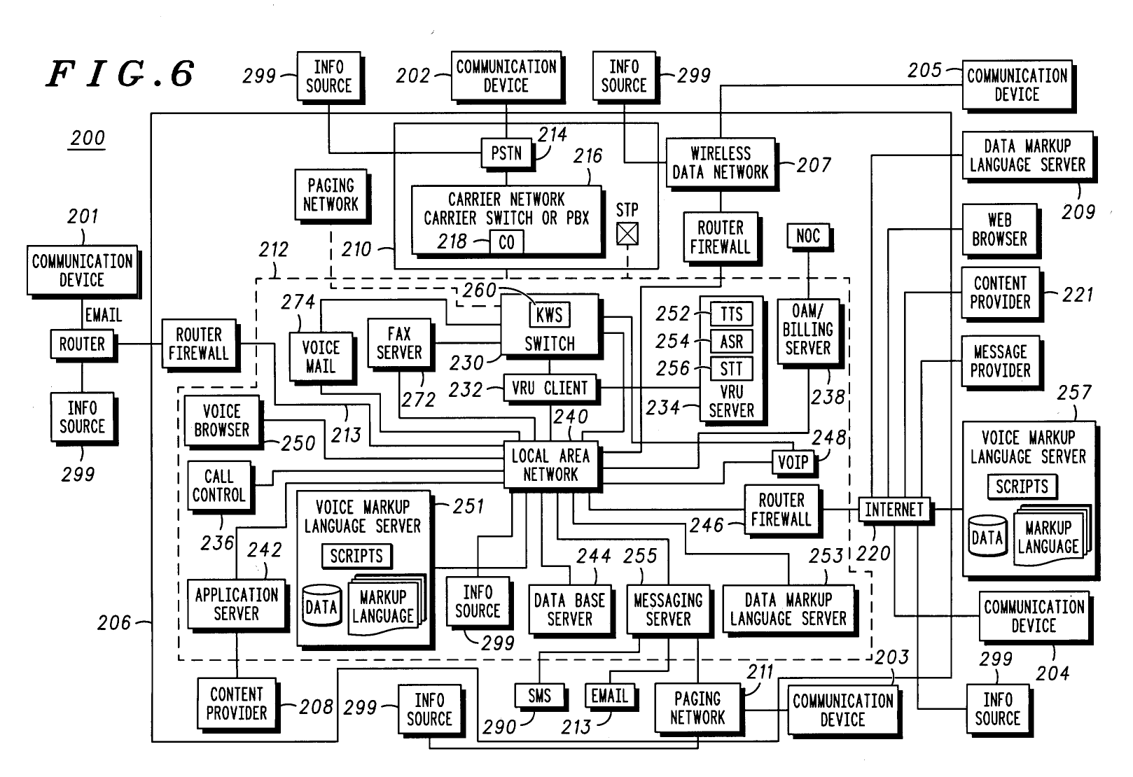

The communication node 16 of the communication system 10 can include, but is not limited to, an interactive voice response node, a server computer, the MIX platform and the Myosphere™. Service provided by Motorola, Inc. of Schaumburg, Ill. (as further described with reference to FIG. 6), or other suitable system. It will be recognized that the communication node 16 may be integrated within or may be remote from the communication networks 14, 18, 19. The communication node 16 can provide information to one or more end users 20.

The information source 30 of the communication system communicates with the communication node 16 via the communication network 18. The information source 30 may be any communication device capable of transmitting or sending information to the communication node 16. The information source 30 may be operated by any entity, including, without limitation, a governmental agency, a commercial entity, or any other suitable source of information. The communication network 18 can interface with the information source 30 through wireline or wireless networks or systems (i.e., telephone or televisions systems, Integrated Services Digital Network (ISDN) systems, coaxial lines, computer networks, digital end user lines, private networks, wireless local loop systems, etc.). It will be recognized that the information source 30 can be integrated into the communication node 16 or communication network 14, 18, 19.

The terminal 26 of the communication system 10 can be utilized by end users or subscribers 20 to access and/or connect with the communication node 16. The terminal 26 may be another communication device like that shown at 12 and can include, but is not limited to, a wireline telephone, a mobile telephone, a paging unit, a radio unit, a wireless data device, a Internet telephone, a portable or wireless telephone, a personal information management devices (PIM), a personal digital assistant (PDA), a personal computer (PC), a network television (TVs), an Internet TV, an Internet telephone, a portable wireless device (i.e., a two-way pager), a security system (both mobile and premises-based), information appliance, e-commerce appliances, a workstation or any other suitable communication device.

The terminal 26 communicates with the communication node 16 via the communication network 19. The communication network 19 can interface with the terminal 26 through wireline or wireless networks or systems (i.e., telephone or televisions systems, Integrated Services Digital Network (ISDN) systems, coaxial lines, computer networks, digital end user lines, private networks, wireless local loop systems, etc.)

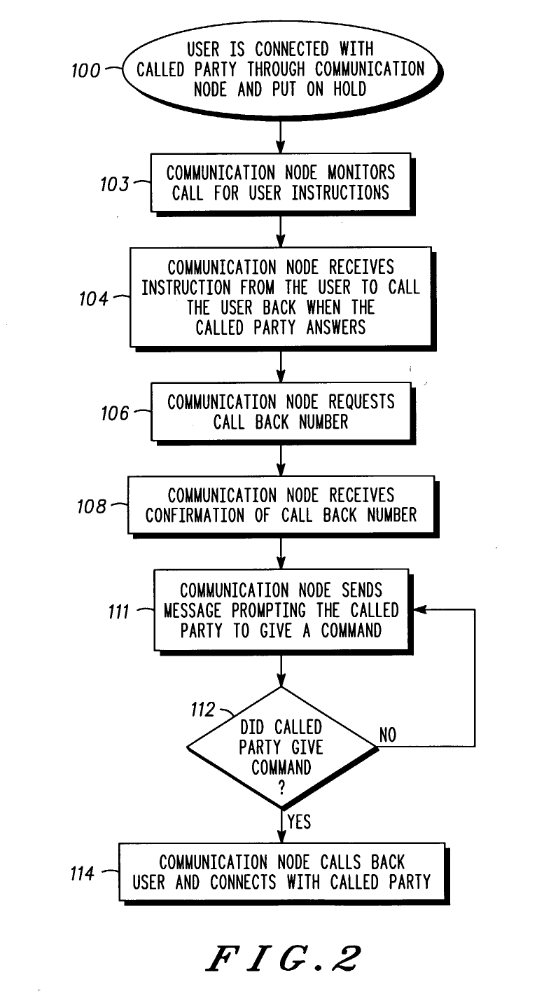

Referring to FIG. 2, the operation of one embodiment of the information accessing routine is illustrated. A user calls a called party and is then put on hold (Block 100). The “called party’ is any entity that may receive a call from a user, including but not limited to: another user, an automated system, a queue for incoming phone calls, another communication device 12 and an information source 30. The connection between the user and called party is made by the user first placing a first call to the communication node (first connection) and then instructing the node to call the called party. Once instructed, the node would make a second call to the called party (second connection) and link the first and second calls to establish the connection between the user and called party. Alternatively, a user may call the called party directly, and, after being placed on hold, connecting to the communication node.

Once the user is connected to the communication node, the node may continuously monitor the connection for an instruction from the user as shown at 103. The user could, for example, instruct the communication node to “Call me back when called party answers.” (Block 104). In one embodiment, the node monitors only the first connection between the node and not the complete connection between the user and called party. However, the node may also monitor both the first connection and the second connection.

Once the communication node receives instruction from the user at Block 104, the communication node may request a phone number where the user can be reached (call back number) as shown at Block 106. The user may then enter in an actual phone number, for example, as confirmation of the call back number (Block 108). For one alternative, the user may give a further verbal instruction, for example, “Call this number.” As another alternative, the communication node may use the user's caller identification, i.e., ANI, as the callback number and, thus, skip any steps requiring the user to explicitly state or otherwise enter the callback number.

The user may then disconnect from the node (the first connection) and the called party (the second connection). At this time the user is no longer on hold and is free to do other things without having to worry about losing the call itself or going through the frustration of holding for a indeterminate length of time. Meanwhile, the communication node 16 maintains the connection and remains “on the line” until the call is answered by the called party.

When the called party returns to the connection, the communication node can send a message prompting the called party to give a command, as shown at Block 111 (e.g., “Sony, Bob had to leave. Shall I call him back now that you've answered?”) As shown at Block 112, if the called party does not respond with a command, the communication node can continue to prompt for a command. If the called party responds with a command, the communication node can use the callback number to call the user and connect the user and called party as shown at Block 114. In another embodiment of the invention, when the called party returns to the connection, the communication node could answer the called party with a message, such as for example, “Please wait while I get Bob on line for you” and immediately call back the user as shown in 114, bypassing the called party command sequence.

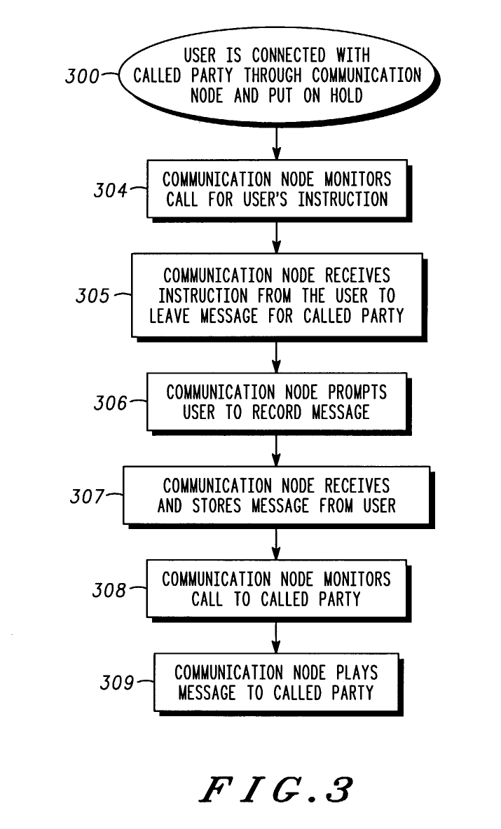

Referring now to FIG. 3, a user and a called party are connected and having a conversation when the user is put on hold at Block 300. In one embodiment of the present invention, the connection between the user and called party is made by the user first placing a first call to the communication node (first connection) and then instructing the node to call the called party. The node would make a second call to the called party (second connection) and link the first and second calls to establish the connection between the user and called party. Alternatively, a user could call the called party separately from the communication node and then, after being placed on hold, could connect to the communication node.

Once the user is connected to the communication node, the node may continuously monitor the connection for an instruction from the user as shown at 304. For example, the user may say, “I can't stay on the line any longer. Please give Tom the following message when he gets back.” Once the communication node receives instruction from the user at Block 305, the communication node may prompt for additional instructions or information, for example “Please record your message at the tone, Bob” as shown at Block 306. The communication node then receives and stores the message as shown at Block 307. Meanwhile, the user may disconnect from the node (the first connection) and the called party (the second connection). The communication node 16 maintains the connection and remains “on the line”, monitoring the connection as shown at Block 308, until the called party returns to the connection.

When the called party returns to the connection; the communication node can respond to the called party, for example “Bob had to leave but he left the following message for you” and then carry out the users command by playing the message, as shown at 309. Then both the called party and the communication node can disconnect without further ado.

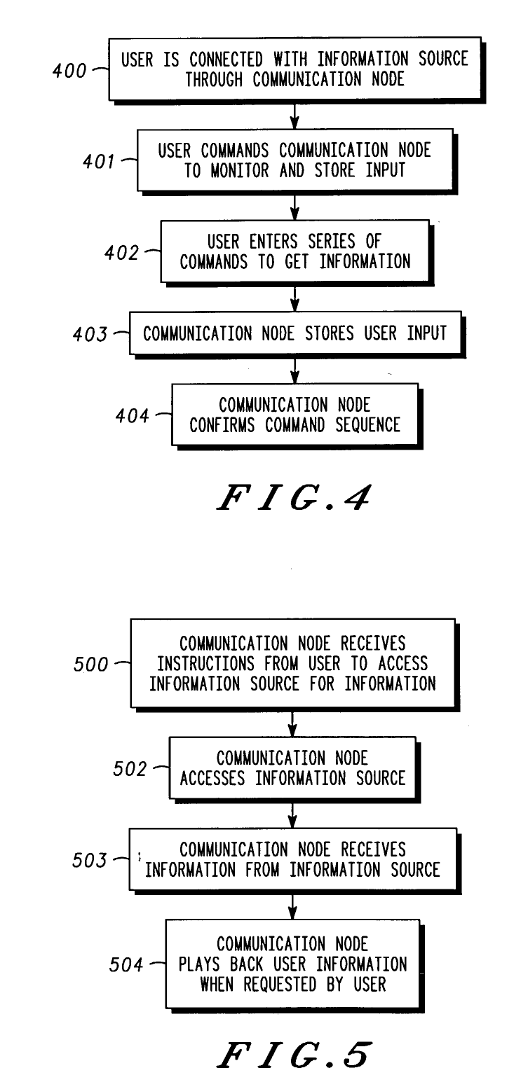

Referring now to FIGS. 4 and 5, two segments of a routine for calling a called party, such as an information source. For specific information are shown. In FIG. 4, a user makes a first call to an information source for specific information at Block 400. For example, a user may call a bank for an account balance. In one embodiment of the present invention, the connection between the user and information source is made by the user first placing a first call to the communication node (first connection) and then instructing the node to call the called party. The node would make a second call to the information source (second connection) and link the first and second calls to establish the connection between the user and information source. Alternatively, a user may call the information source separately from the communication node and then connect to the communication node.

Once the user is connected to the communication node and the information source, the user may command the communication node to monitor and store the interactions between the user and the information source. For example, the user may say, “Memorize the commands I use in order to obtain my account balance” at Block 401. These commands, may be, for example, be a series of instructions that the user may input into an automated system in order to obtain information (Block 402). These instructions may take any form, including, but not limited to, verbal commands, keystrokes or numerical sequences. For example, the user may call the bank and then enter in a sequence of numbers which indicate the desire to see an account balance (e.g., Pressing I then the pound key, then entering an account number and then the pound key to get an account balance). A user might also call a bank and give a teller verbal information which enables the user to access a bank account. The node may continuously monitor the connection during this time and store all user inputs (Block 403). It is contemplated that the communication node could also prompt for additional instructions or information during this time, for example “Shall I memorize your account number?” or “Shall I press ‘I’ for account balance?” (Block 404). The user, having obtained the desired information from this first call, may then disconnect from the node (the first connection) and the information source (the second connection).

Once the initial segment of the routine for calling an information source for specific information shown in FIG. 4 is completed, this segment no longer has to be repeated the next time the user desires the information. As shown in FIG. 5, the user may subsequently instruct the communication node to call the information source (e.g., the user wants to check an account balance again) at Block 500. The communication node connects to the information source at Block 502 and enters all the information memorized from the routine of FIG. 4 in order to obtain the desired information (Block 503). Having obtained the information, the communication node then provides the user with the information at Block 504. The communication node could call the user back with the information, for example, or the user could connect to the node at a later time in order to retrieve the information. The user is thus able to obtain information without having to stay on hold or repetitively enter a series of commands for information.

It is also contemplated that a user may connect to the communication node and provide information to the node that would allow the node to obtain information from a third party on behalf of the user, without having to place an initial call to the third party (as described in FIG. 4). For example, a user might provide the node with account numbers and passwords. Then, at Block 500, the user instructs the node to access the information source and at Block 502, the communication node uses the information provided by the user to interact with the information source in order to retrieve information (Block 503).

FIG. 6 is an exemplary block diagram of one embodiment of a communication system 200 in accordance with the present invention. The communication system can implement the routines described in FIGS. 2-5 above. The communication system 200 generally includes one or more communication devices 201, 202, 203, 204, 205 (five being shown), an electronic network 206, and one or more information sources (e.g., content providers 208, 221,299 and data and voice markup language servers 209, 251, 253, 257).

The subscriber can access the electronic network 206 by dialing a single direct access telephone number (e.g., a foreign exchange telephone number, a local telephone number, or a toll-free telephone number or PBX) from the communication device 201. The subscriber can also access the electronic network 206 from the communication device 202 via the Internet 220 or WWW, from the communication device 203 via a paging network 211, or from the communication device 205 via a LAN, a WAN, an e-mail connection or in any other similar manner.

As shown in FIG. 6, the electronic network 206 includes a telecommunication network 210 and a communication node 212. The telecommunication network 210 is preferably connected to the communication node 212 via a high-speed data link, such as, for example, a T1 telephone line, a LAN, a WAN or a VOIP network. The telecommunication network 210 preferably includes a PSTN 214 and a carrier network 216. The telecommunication network 210 can also include, for example, international or local exchange networks, cable TV networks, inter-exchange carrier or long distance carrier networks, cellular networks (e.g., mobile switching centers), PBXs, satellite systems, wireless data networks and other switching centers such as conventional or trunked radio systems (not shown), etc. The electronic network 206 can also include additional telecommunication networks, such as, for example, a wireless data network 207.

The PSTN 214 can include various types of communication equipment, such as, for example, ATM networks, Fiber Distributed Data networks (FDDI), T1 lines, cable TV networks, VOIP networks and the like. The carrier network 216 generally includes a telephone switching system or CO 218. It will be recognized that the carrier network 216 can be any suitable system that can route calls to the communication node 212, and the CO 218 can be any suitable wire-line or wireless switching system.

The communication node 212 is preferably configured to receive and process incoming calls from the carrier network 216 and the Internet 220. The communication node 212 can receive and process pages from the paging network 211 and can also receive and process messages (e.g., e-mails) from the LAN, WAN, wireless data or e-mail system 213.

When a subscriber dials into the electronic network 206 from the communication device 201, the carrier network 216 routes the incoming call from the PSTN 214 to the communication node 212 over one or more telephone lines or trunks. The incoming calls preferably enter the carrier network 216 through one or more “888” or “800” Inward Wide Area Telecommunications Services trunk lines, local exchange or long distance trunk lines. It is also contemplated that the incoming calls can be received from a cable, cellular or VOIP network or any other suitable system.

The communication node 212 answers the incoming call from the carrier network 216 and retrieves an appropriate announcement (e.g., a welcome greeting) from a database, server or browser. The communication node 212 then plays the announcement to the caller. In response to audio inputs from the subscriber, the communication node 212 retrieves information from a destination or database of one or more of the information sources, such as the content providers 208,221 or the markup language servers 209,251, 253,257. After the communication node 212 receives the information, it provides a response to the subscriber based upon the retrieved information.

The communication node 212 can provide various dialog voice personalities (e.g., a female voice, a male voice, etc.), and can implement various grammars (e.g., vocabulary) to detect and respond to the audio inputs from the subscriber. In addition, the communication node 212 can automatically select various speech recognition models (e.g., English, Spanish or English accent models) based upon a subscribers profile, communication device and/or speech patterns. The communication node 212 can also allow the subscriber to select a particular speech recognition model.

When a subscriber accesses the electronic network 206 from a communication device 201, 202, 203, 204, 205 registered with the system (e.g., home telephone, work telephone, cellular telephone, etc.), the communication node 212 can by-pass a subscriber screening option and automatically identify the subscriber (or the type of communication device) through the use of ANI or CLI. After the communication node 212 verifies the call, the communication node 212 provides a greeting (e.g., “Hi, this is your personal agent, Maya. Welcome Bob. How may I help you?”). The communication node 212 then enters into a dialogue with the subscriber, and the subscriber can select a variety of services offered by the communication node 212.

When the subscriber accesses the electronic network 206 from a communication device not registered with the system (e.g., a payphone, a telephone of a non-subscriber, etc.), the communication node 212 answers the call and prompts the subscriber to enter his or her name and/or a personal identification number (PIN) using voice commands or DTMF signals. The communication node 212 can also utilize speaker verification to identify the particular speech pattern of the subscriber. If the communication node 212 authorizes the subscriber to access the system, the communication node 212 provides a personal greeting to the subscriber (e.g., “Hi, this is your personal agent, Maya. Welcome Ann. How may I help you?”). The communication node 212 then enters into a dialogue with the subscriber, and the subscriber can select various services offered by the communication-node 212. If the name and/or PIN of the subscriber cannot be recognized or verified by the communication node 212, the subscriber will be routed to a customer service representative.

Once the subscriber has accessed the communication system 200, the subscriber may implement a wide variety of services and features by using voice commands, such as, for example, voice dialing, voice paging, facsimiles, caller announcements, voice mails, reminders, call forwarding, call recording, content information (e.g., newspapers, etc.), read e-mail, read calendars, read “to-do” lists, banking, e-commerce. The communication system 200 can place outbound calls and pages to business and personal parties or contacts (e.g., friends, clients, business associates, family members, etc.) in response to DTMF signals or voice commands. The calls can be routed through a telephone or electronic network to the selected party and the pagers can be sent to a selected party via a paging system. The communication system 200 can also receive calls routed through a telephone or electronic network.

As shown in FIG. 6, the communication node 212 preferably includes a telephone switch 230, a voice or audio recognition (VRU) client 232, a VRU server 234, a controller or call control unit 236, an Operation and Maintenance Office or a billing server unit 238, a LAN 240, an application server unit 242, a database server unit 244, a gateway server or router firewall server unit 246, a VOIP unit 248, a voice browser 250, a voice markup language server 251, a messaging server 255 and a data markup language server 253. Although the communication node 212 is shown as being constructed with various types of independent and separate units or devices, the communication node 212 can be implemented by one or more integrated circuits, microprocessors, microcontrollers or computers which may be programmed to execute the operations or functions equivalent to those performed by the devices or units shown. It will also be recognized that the communication node 212 can be carried out in the form of hardware components and circuit devices and/or software or computer programs.

The communication node 212 can be located in various geographic locations throughout the world or the United States (e.g., Chicago, Ill.). The communication node 212 can be operated by one or more carriers (e.g., Sprint, Qwest, MCI, etc.) or independent service providers (e.g., Motorola, Inc.).

The communication node 212 can be integrated with the carrier network 216 or can be located remote from the carrier network 216. It is also contemplated that the communication node 212 may be integrated into a communication device, such as, for example, a wire-line or wireless telephone, a radio device, a PC, a PDA, a PIM, etc., and can be programmed to connect or link directly to an information source.

The communication node 212 can also be configured as a standalone system to allow end users to dial directly into the communication node 212 via a direct access telephone number. In addition, the communication node 212 may comprise a telephony switch (e.g., a PBX or Centrix unit), an enterprise network or a LAN. In this configuration, the communication system 200 can be implemented to automatically connect a subscriber to the communication node 212 when the subscriber accesses a communication device.

When the telephone switch 230 receives an incoming call from the carrier network 216, the call control unit 236 sets up a connection in the telephone switch 230 to the VRU client 232. The communication node 212 then enters into a dialog with the subscriber regarding various services and functions. The VRU client 232 preferably generates pre-recorded voice announcements and/or messages to prompt the subscriber to provide inputs to the communication node 212 using voice commands or DTMF signals. In response to the inputs from the subscriber, the communication node 212 retrieves information from a destination of one of the information sources and provides outputs to the subscriber.

The telephone switch 230 is preferably connected to the VRU client 232, the VOIP unit 248 and the LAN 240. The telephone switch 230 receives incoming calls from the carrier network 216. The telephone switch 230 also receives incoming calls from the communication device 202 routed over the Internet 220 via the VOIP unit 248. The telephone switch 230 also receives messages and pages from communication devices 203, 205, respectively. The telephone switch 230 is preferably a digital cross-connect switch, Model LNX, available from Excel Switching Corporation, Hyannis, Mass. It will be recognized that the telephone switch 230 can be any suitable switch.

The VRU client 232 is preferably connected to the VRU server 234 and the LAN 240. The VRU client 232 processes voice communications, DTMF signals, pages and messages (e.g., e-mails). Upon receiving voice communications, the VRU client 232 routes the speech communications to the VRU server 234. When the VRU client 232 detects DTMF signals, it sends a command to the call control unit 236. It will be recognized that the VRU client 232 can be integrated with the VRU server 234.

The VRU client 232 preferably comprises a PC, such as, for example, a Windows NT compatible PC, with hardware capable of connecting individual telephone lines directly to the telephone switch 230 or carrier network 216. The VRU client 232 preferably includes a microprocessor, random access memory, read-only memory, a T1 or ISDN interface board, and one or more voice communication processing boards (not shown). The voice communication processing boards are preferably Dialogic boards, Antares Model, available from Dialogic Corporation, Parsippany, N.J. The voice communication boards may include a voice recognition engine having a vocabulary for detecting a speech pattern. The voice recognition engine is preferably a RecServer software package, available from Nuance Communications, Menlo Park, Calif.

The VRU client 232 can also include an echo canceller (not shown) to reduce or cancel iTS or playback echoes transmitted from the PSTN 214 due to hybrid impedance mismatches. The echo canceller is preferably included in an Antares Board Support Package, also available from Dialogic.

The call control unit 236 is preferably connected to the LAN 240, and sets up the telephone switch 230 to connect incoming calls to the VRU client 232. The call control unit 236 also sets up incoming calls or pages to the communication node 212 over the Internet 220 and pages and messages sent from the communication devices 203,205 via the paging network 211 and e-mail system 213, respectively. The control call unit 236 preferably comprises a PC, such as, for example, a Windows NT compatible PC.

The LAN 240 allows the various components and devices of the communication node 212 to communicate with each other via twisted pair, fiber optic, coaxial cables or the like. The LAN 240 may use Ethernet, Token Ring or other suitable types of protocols. The LAN 240 is preferably a 100 Megabit per second Ethernet switch, available from Cisco Systems, San Jose, Calif., and can comprise any suitable network system. The communication node 212 may include a plurality of LANs.

The VRU server 234 is connected to the VRU client 232 and the LAN 240. The VRU server 234 receives voice communications from the subscriber via the VRU client 232. The VRU server 234 processes the voice communications and compares the voice communications against a vocabulary or grammar stored in the database server unit 244 or a similar memory device. The VRU server 234 provides output signals, representing the result of the voice communications processing, to the LAN 240. The LAN 240 routes the output signal to the call control unit 236, the application server unit 242 and/or the voice browser 250. The communication node 212 then performs a specific function associated with the output signals.

The VRU server 234 preferably includes a TTS unit 252, an automatic speech recognition (ASR) unit 254, and a SiT unit 256. The TTS unit 252 receives textual data or information (e.g., e-mail, web pages, documents, files, etc.) from the application server unit 242, the database server unit 244, the call control unit 236, the gateway server unit 246, the application server unit 242 and the voice browser 250. The US unit 252 processes the textual data and converts the data to voice data or information.

The US unit 252 can provide data to the VRU client 232, which reads or plays the data to the subscriber. For example, when the subscriber requests information (e.g., news updates, stock information, traffic conditions, etc.), the communication node 212 retrieves the desired data (e.g., textual information) from a destination of the one or more of the information sources and converts the data via the US unit 252 into a response.

The response is then sent to the VRU client 232. The VRU client 232 processes the response and reads an audio message to the subscriber based upon the response. It is contemplated that the VRU server 234 can read the audio message to the subscriber using human recorded speech or synthesized speech. The US unit 252 is preferably a US 2000 software package, available from Lernout and Hauspie Speech Product NV, Burlington, Mass.

The ASR unit 254 provides speaker dependent or independent automatic voice recognition of voice communications from the subscriber. It is contemplated that the ASR unit 254 can include speaker dependent voice recognition. The ASR unit 254 processes the voice communications to determine whether a word or a speech pattern matches any of the grammars or vocabulary stored in the database server unit 244 or downloaded from the voice browser 250. When the ASR unit 254 identifies a selected speech pattern of the voice communications, the ASR unit 254 sends an output signal to implement the specific function associated with the recognized speech pattern. The ASR unit 254 is preferably a speaker independent voice recognition software package, RecServer Model, also available from Nuance Communications. It is contemplated that the ASR unit 254 can be any suitable voice recognition unit to detect voice communications.

The SiT unit 256 receives voice communications and converts the voice communications to textual information (e.g., a text message). The textual information can be sent or routed to the communication devices 201, 202, 203, 204,205, the content providers 208, 221, the markup language servers 209, 251, 253,257, the voice browser 250 and the application server unit 242. The SiT unit 256 is preferably a Naturally Speaking software package, available from Dragon Systems, Newton, Mass.

The VOIP unit 248 is preferably connected to the telephone switch 230 and the LAN 240. The VOIP unit 248 allows a subscriber to access the communication node 212 via the Internet 220 or VOIP public network using voice commands. The VOIP unit 248 can receive VOIP protocols (e.g., H.323 protocols) transmitted over the Internet 220 or Intranet, and can convert the VOIP protocols to voice information or data. The voice information can then be read to the subscriber via the VRU client 232. The VOIP unit 248 can also receive voice communications from the subscriber and convert the voice communications to a VOIP protocol that can be transmitted over the Internet 220. The VOIP unit 248 is preferably a Voice Net software package, also available from Dialogic Corporation. It will be recognized that the VOIP unit 248 can be incorporated into a communication device.

The communication node 212 also includes a detection unit 260. The detection unit 260 is preferably a phrase or key word spotter unit, detecting incoming audio inputs or communications or DTMF signals from the subscriber. The detection unit 260 is preferably incorporated into the telephone switch 230, but can be incorporated into the VRU client 232, the carrier network 216 or the VRU server 234. The detection unit 260 is preferably included in a RecServer software package, also available from Nuance Communications.

The detection unit 260 records the audio inputs from the subscriber and compares the audio inputs to the vocabulary or grammar stored in the database server unit 244 The detection unit 260 continuously monitors the subscribers audio inputs for a key phase or word after the subscriber is connected to the node 212. When the detection unit 260 detects the key phrase or word, the VRU client 232 plays a pre-recorded message to the subscriber. The VRU client 232 then responds to the audio inputs provided by the subscriber.

The billing server unit 238 is preferably connected to the LAN 240. The billing server unit 238 can record data about the use of the communication node 212 by a subscriber (e.g., length of calls, features accessed by the subscriber, etc.). Upon completion of a call by a subscriber, the call control unit 236 sends data to the billing server unit 238. The billing server unit 238 can subsequently process the data in order to prepare customer bills. The billing server unit 238 can use the ANI or CLI of the communication device to properly bill the subscriber. The billing server unit 238 preferably comprises a Windows NT compatible PC.

The gateway server unit 246 is preferably connected to the LAN 240 and the Internet 220. The gateway server unit 246 provides access to the content provider 221 and the voice markup language server 257 via the Internet 220. The gateway server unit 246 allows end users to access the communication node 212 from the communication device 202 via the Internet 220. The gateway server unit 246 can function as a firewall to control access to the communication node 212 to authorized end users. The gateway server unit 246 is preferably a Cisco Router, also available from Cisco Systems.

The database server unit 244 is preferably connected to the LAN 240. The database server unit 244 preferably includes a plurality of storage areas to store data relating to end users, such as, for example, speech vocabularies, dialogs, personalities, subscriber entered data, and other information. Preferably, the database server unit 244 stores a personal file or address book. The personal address book can contain information-required for the operation of the communication system 200, including subscriber reference numbers, personal access codes, personal account information, contact's addresses, telephone numbers, etc. The database server unit 244 is preferably a PC, such as, for example, a Windows NT compatible PC.

The application server unit 242 is preferably connected to the LAN 240 and the content provider 208. The application server unit 242 allows the communication node 212 to access information from a destination of the information sources, such as the content providers 208, 221, information sources 299 and the markup language servers 209, 251, 253, 257. For example, the application server unit 242 can retrieve information (e.g., weather reports, stock information, traffic reports, restaurants, flower shops, banks, calendars, “to-do” lists, e-commerce, etc.) from a destination of the information sources 299. This application server unit 242 may include Starfish Software to provide the address book, calendar and to-do lists, and to allow the subscriber to organize information. The application server unit 242 processes the retrieved information and provides the information to the VRU server 234 and the voice browser 250. The VRU server 234 can provide an audio announcement to the subscriber based upon the information using iTS synthesizing or human recorded voice. The application server unit 242 can also send tasks or requests (e.g., transactional information) received from the subscriber to the information sources 299 (e.g., a request to place an order for a pizza). The application server unit 242 can further receive subscriber inputs from the VRU server 234 based upon a speech recognition output. The application server unit 242 is preferably a PC.

The voice markup language server 251 is preferably connected to the LAN 240. The voice markup language server 251 can include a database, scripts and markup language documents or pages. The voice markup language server 251 is preferably a PC, such as, for example, a Windows NT compatible PC. It will also be recognized that the voice markup language server 251 can be an Internet server (e.g., a Sun Microsystems server).

The messaging server 255 is preferably connected to the LAN 240, the paging network 211, an e-mail system 213 and a short message system (SMS) 290. The messaging server 255 routes pages between the LAN 240 and the paging network 211. The messaging server 255 is preferably a PC, such as, for example, a Windows NT compatible PC. The messaging server 255 can also provide direct storage. It is contemplated that the messaging server 255 can reside externally from the communication node 212.

The voice browser 250 is preferably connected to the LAN 240. The voice browser 250 preferably receives information from the markup language servers 209, 251, 253, 257, the database server unit 244 and the content providers 208, 221. In response to voice commands or DTMF signals, the voice browser 250 generates a content request (e.g., an electronic address) to navigate to a destination of one or more of the information sources. The content request can use at least a portion of a Uniform Resource Locator, an Internet Protocol, a page request, or e-mail.

After the voice browser 250 is connected to an information source, the voice browser 250 preferably uses a Transmission Control Protocol/Internet Protocol connection to pass requests to the information source. The information source responds to the requests, sending at least a portion of the requested information, represented in electronic form, to the voice browser 250. The information can be stored in a database, and can include text content, markup language document or pages, non-text content, dialogs, audio sample data, recognition grammars, etc. The voice browser 250 then parses and interprets the information, further described below. The voice browser 250 can be integrated into the communication devices 201, 202,203,204, 205.

As shown in FIG. 6, the content provider 208 is connected to the application server unit 242 of the communication node 212, and the content provider 221 is connected to the gateway server unit 246 of the communication node 212 via the Internet 220. The content providers 208, 221 can store various content information, such as news, banking, commerce, weather, traffic conditions, etc. The content providers 208, 221 can include a server to operate WWW pages or documents in the form of a markup language. The content providers 208, 221 can also include a database, scripts and/or markup language documents or pages. The scripts can include images, audio, grammars, computer programs, etc. The content providers 208, 221 execute suitable server software to send requested information to the voice browser 250.

The voice mail unit 274 is preferably connected to the telephone switch 203 and the LAN 240. The voice mail unit 274 can store voice mail messages from parties trying to send messages to the communication node 212. When a subscriber accesses the electronic network 206, the voice mail unit 274 can notify the subscriber of new and stored messages. The subscriber can access the messages to play, delete, store and forward the messages. When the subscriber accesses a message, the message can be read to the subscriber or can be displayed as textual information on a communication device (e.g., a pager, a SMS 290, or a PDA, etc.). The subscriber can also access and operate external messages or mail systems remote from the electronic network 206.

The FAX server unit 272 is preferably connected to the telephone switch 230 and the LAN 240. The FAX server unit 272 receivers and stores facsimile information sent via the electronic network 206 or the carrier network 216. Subscribers can access the facsimile information to play, store, delete, and forward the information. The facsimile information can be read via the iTS unit 252 or can be displayed as textual information on a suitable communication device. The FAX server unit 272 preferably comprises a PC, such as, for example, a Windows NT compatible PC or a Dialogue Fax Server.

It should be appreciated that the embodiments described above are to be considered in all respects only illustrative and not restrictive. The scope of the invention is indicated by the following claims rather than by the foregoing description. All changes that come within the meaning and range of equivalents are to be embraced within their scope.

We claim:

1. A method of accessing an information source through a communication node comprising the steps of:
monitoring a first call placed by a user to the information source;
receiving at least one access input from the user;
storing the access input; and
playing back the stored access input to access the information source.

2. The method of claim 1:
wherein the access input from the user comprises at least one command that obtains information from the information source; and
further comprising the step of storing the information received from the information source.

3. The method of claim 2 further comprising the steps of:
connecting the communication node to the user; and
providing the stored information to the user.

4. The method of claim 1 wherein the first call is placed from a communication device via the communication node.

5. The method of claim 4 wherein the communication device is selected from the group consisting of:
a wireline telephone; a mobile telephone; a paging unit; a radio unit; a wireless data device; an Internet telephone; a portable telephone; a wireless telephone; a personal information management device; a personal digital assistant; a personal computer; a network television; an Internet television; an Internet telephone; a portable wireless device; a security system; an information appliance; an e-commerce appliance; and a workstation.

6. The method of claim 1 wherein the first call is placed from the communication device via the communication node to the information source.

7. The method of claim 1 wherein the communication node is connected via a communication network.

8. The method of claim 7 wherein the network is selected from the group consisting of: an intranet; an extranet; an Internet; a local area network; a telephone network; a cellular network; a satellite network; a personal communication system; a TV network; a paging network; an e-mail system; a wireless data networks; a wireless local area network; a wireless local loop/distribution system; and a voice over internet protocol network.

9. The method of claim 1 further comprising the step of placing a second call to the information source.

10. The method of claim 9 wherein the second call is placed from the communication node to a user-identified communication device.

11. The method of claim 9 wherein the second call is placed by the user through a communication device via the communication mode.

12. The method of claim 1 further comprising initiating the communication mode to monitor and store the access input.

13. A program for accessing an information source through a communication node comprising:
computer readable program code that monitors a first call placed by a user to a information source;
computer readable program code that receives at least one access input from the user;
computer readable program code that stores the access input; and
computer readable program code that plays back the stored access input to access the information source.

14. The program of claim 13 wherein the access input from the user comprises at least one command that obtains information from the information source, further comprising:
computer readable program code that stores the information received from the information source.

15. The program of claim 14, further comprising:
computer readable program code that connects the communication node to the user; and
computer readable program code that provides the stored information to the user.

16. The program of claim 13 wherein the first call is placed from a communication device via the communication node.

17. The program of claim 13 wherein the first call is placed from the communication device via the communication node to the information source.

18. The program of claim 13 further comprising computer readable program code that places a second call to the information source.

19. The program of claim 18 wherein the second call is placed from the communication node to a user-identified communication device.
